(19) United States
(12) Patent Application Publication
(10) Pub. No.: US 2018/0144599 A1
(43) Pub. Date: May 24, 2018

(54) BEHAVIOR DETECTION SYSTEM AND METHOD THEREOF

(71) Applicant: INSTITUTE FOR INFORMATION INDUSTRY, Taipei City (TW)

(72) Inventors: PIN-LIANG CHEN, NEW TAIPEI CITY (TW); PING-CHE YANG, TAIPEI CITY (TW); TSUN KU, TAIPEI CITY (TW)

(21) Appl. No.: 15/377,992

(22) Filed: Dec. 13, 2016

(30) Foreign Application Priority Data
Nov. 23, 2016 (TW) 105138484

(51) Int. Cl. G08B 21/04

(52) U.S. Cl. CPC G08B 21/0407; G08B 21/0469; G08B 21/0476

(57) ABSTRACT

Disclosed are a behavior detection system and a method thereof. The behavior detection method is executed by the behavior detection system, and includes: pre-storing a plurality of event types, behavior modes and a normal life mode, wherein each event type includes corresponding reference signals, and the behavior mode includes a plurality of event types arranged in a specific order, and the normal life mode records the behavior modes in different past time intervals in each day; comparing sensing signals and the reference signals, and determining an event; and obtaining a current behavior mode and its first possibility according to event types, the specific order of event types and the pre-stored behavior modes in the current time interval, obtaining a second possibility by comparing the current behavior mode and the normal life mode, and finally determining whether to send an alarm according to the first possibility and the second possibility.

### BACKGROUND OF THE INVENTION

### 1. Field of the Invention

The instant disclosure relates to a behavior detection system and a behavior detection method; in particular, to a behavior detection system and a behavior detection method that can detect a behavior according to a plurality of sensing signals obtained by different types of detectors.

### 2. Description of Related Art

With technology developed, there are more and more homecare system developed. Nowadays, most people need to work or go to school in day time and thus cannot stay at home to take care of their parents or kids. Therefore, when people are not at home, most of them would like to be informed if there is any accident happening to the elderly or kids at home.

For some homecare systems, they use camera to monitor whether there is any accident happening to the elderly or kid at home; however, there will be a concern that the monitored people have no privacy. For still some homecare systems, they have audio receivers configured on the floor to determine whether the elderly may fall down according to audio signals from the audio receiver; however, determining whether the elderly may fall down only according to the audio signals from the audio receiver often results in error determinations. For still some homecare systems, the people being cared need to wear a wearable device, it can determined whether the people being cared is in danger according to sensing signals obtained by the wearable device, such as signals received by the multi-axis accelerometer. However, it really not that convenient to wear the wearable device anytime (such as, when one is taking a bath). Thus, considering about the above mentioned inconvenience and people's needs, a behavior detection system that will not often make a wrong determination to send an error notification, can give people privacy and needs no wearable device worn by people is quite needed.

### SUMMARY OF THE INVENTION

The instant disclosure provides a behavior detection system. This behavior detection system obtains a plurality of sensing signals from a plurality of sensors to detect a behavior, and accordingly determines whether to send a notification to an external device. This behavior detection system comprises a storage module, an event type classification module and a behavior evaluation module. A plurality of event types, a plurality of behavior modes and a life mode are previously stored in the storage module. Each event type corresponds to a plurality of reference signals. Each behavior mode comprises a plurality of event types arranged in a specific order. The life mode records a plurality of behavior modes in a plurality of past time intervals, and the past time intervals correspond to different time segments of a day. The event type classification module is connected to the storage module. The event type classification module compares the sensing signals and the reference signals corresponding to the event types. After that, the event type classification module determines the event types of the events corresponding to the sensing signals. The behavior evaluation module is connected to the behavior evaluation module and the event type classification module. The behavior evaluation module obtains a current behavior mode and a first possibility according to the previously stored behavior modes, the event types and the specific order of the event types which are related to the determined events within a current time interval. After that, the behavior evaluation module compares the current time interval and the life mode to obtain a second possibility, and then determines whether to send the notification according to the first possibility and the second possibility. The first possibility is defined as a possibility of being in danger in the current behavior mode, and the second possibility is defined as a possibility of the current behavior mode being similar to the behavior modes in the past time intervals corresponding to the current time interval.

In one embodiment of the behavior detection system provided by the instant disclosure, the behavior detection system further comprises a behavior capturing module. The behavior capturing module is connected to the event type classification module. The behavior capturing module packages the event types, the specific order of the event types and the first possibility as one of the behavior modes which are stored in the storage module. In another embodiment of the behavior detection system provided by the instant disclosure, the behavior detection system further comprises a life mode training module. The life mode training module is connected to the event type classification module. To obtain the life mode, the life mode training module takes the determined behavior mode as one of the behavior modes in the past time intervals according to a timing when the behavior mode happened. After that, the life mode training module stores the life mode in the storage module.

The instant disclosure also provides a behavior detection method which is adapted to a behavior detection system. The behavior detection system obtains a plurality of sensing signals from a plurality of sensors to detect a behavior, and accordingly determines whether to send a notification to an external device. The behavior detection system comprises a storage module, an event type classification module and a behavior evaluation module. The event type classification module and the behavior evaluation module are connected to the storage module. The behavior detection method comprises: through the storage module, previously storing a plurality of event types, a plurality of behavior modes and a life mode, wherein each event type corresponds to a plurality of reference signals, each behavior mode comprises a plurality of event types arranged in a specific order, and the life mode records a plurality of behavior modes in a plurality of past time intervals and the past time intervals correspond to different time segments of a day; through the event type classification module, comparing the sensing signals and the reference signals corresponding to the event types and determining the event types of the events corresponding to the sensing signals; and through the behavior evaluation module, obtaining a current behavior mode and a first possibility according to the previously stored behavior modes, the event types and the specific order of the event types related to the determined events within a current time interval, comparing the current time interval and the life mode to obtain a second possibility, and determining whether to send the notification according to the first possibility and the second possibility. The first possibility is defined as a possibility of being in danger in the current behavior mode, and the second possibility is defined as a possibility of the current behavior mode being similar to the behavior modes in the past time intervals corresponding to the current time interval.

In one embodiment of the behavior detection method provided by the instant disclosure, the behavior detection system executing the behavior detection method further comprises a behavior capturing module, and the behavior capturing module is connected to the event type classification module. With the behavior capturing module added to the behavior detection system, the behavior detection method further comprises: through the behavior capturing module, packaging the event types, the specific order of the event types and the first possibility as one of the behavior modes stored in the storage module. In another embodiment of the behavior detection method provided by the instant disclosure, the behavior detection system executing the behavior detection method further comprises a life mode training module, and the life mode training module is connected to the event type classification module. The life mode training module takes the determined behavior mode as one of the behavior modes in the past time intervals according to a timing when the behavior mode happened to obtain the life mode. After that, the life mode training module stores the life mode in the storage module.

To sum up, the behavior detection system and the behavior detection method provided by the instant disclosure can detect a behavior according to different types of signals, such as audio signals, infrared signals or the like. In addition, based on behavior modes learned by the behavior capturing module and the life mode obtained by the life mode training module, the behavior detection system can determine whether to send a notification to an external device for the detected behavior. The behavior detection system and the behavior detection method provided by the instant disclosure can be used in home appliances, to determine whether there is anyone being in danger at home. For example, the elderly may fall down but cannot stand up by themselves. The traditional detection system usually detect a behavior based on single type of signals, and in this manner a behavior may be wrongly determined as a dangerous one. On the contrary, the behavior detection system and method provided by the instant disclosure can detect a behavior according to different types of signals and based on the behavior modes learned by the behavior capturing module and the life mode obtained by the life mode training module, so the behavior detection system and method provided by the instant disclosure can precisely determine whether the detected behavior makes one in danger (or determine the possibility that one may be in danger because of the detected behavior happened), and it will be less likely to wrongly send a notification to warn a user.

For further understanding of the instant disclosure, reference is made to the following detailed description illustrating the embodiments of the instant disclosure. The description is only for illustrating the instant disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a block diagram of a behavior detection system in one embodiment of the instant disclosure.

FIG. 2 shows a block diagram of a behavior detection system in another embodiment of the instant disclosure.

FIG. 3 is a block diagram showing how a behavior capturing module in the behavior detection system obtains a behavior mode in one embodiment of the instant disclosure.

FIG. 4 is a block diagram showing how a life mode training module in the behavior detection system obtains a life mode in one embodiment of the instant disclosure.

FIG. 5 shows a flow chart of a behavior detection method in one embodiment of the instant disclosure.

FIG. 6 shows a flow chart of a behavior detection method in another embodiment of the instant disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

### One Embodiment of the Behavior Detection System

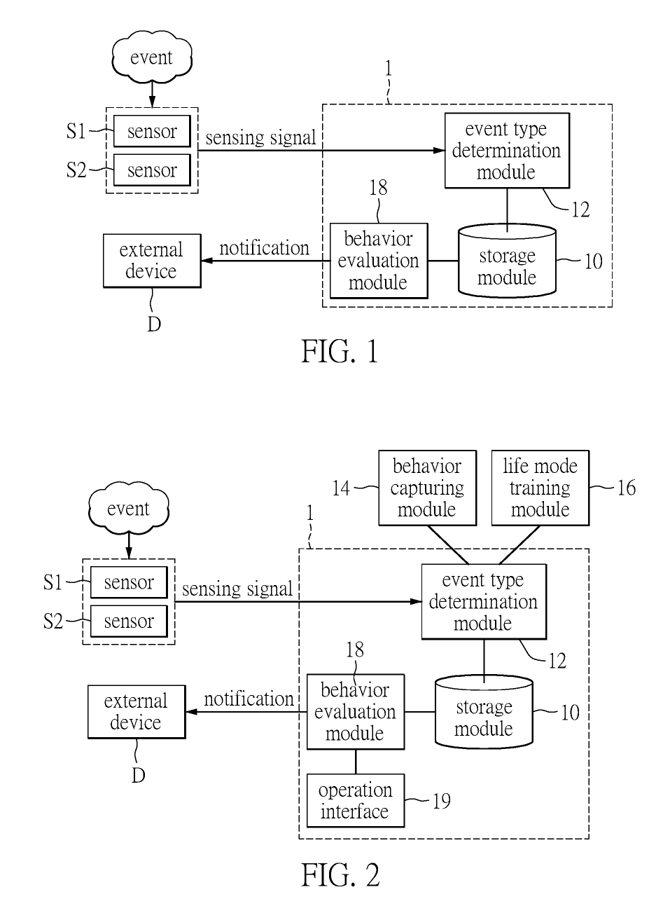

Referring to FIG. 1, FIG. 1 shows a block diagram of a behavior detection system in one embodiment of the instant disclosure. The behavior detection system 1 can be implemented by hardware devices like a computer, a local server, a cloud server or the combination thereof The behavior detection system 1 mainly comprises a storage module 10, an event type classification module 12 and a behavior evaluation module 18. As shown in FIG. 1, the event type classification module 12 and the behavior evaluation module 18 are both connected to the storage module 10. Briefly, the behavior detection system 1 can detect a behavior according to a plurality of sensing signals obtained by a plurality of sensors S1 and S2, and then determines whether to send a notification to a external device D. It should be noted that, the sensors S1 and S2 at least comprise two different types of sensors. For example, the behavior detection system 1 can use an audio detector and an infrared camera to at least obtain an audio signal and an infrared signal. After that, the behavior detection system 1 can detect a behavior, and can further determine whether to send a notification to ab external device D. However, the types of sensor which are used by the behavior detection system are not restricted herein.

The following description is to further illustrate the working principle of the behavior detection system 1.

In this embodiment, a plurality of event types, a plurality of behavior modes and a life mode are previously stored in the storage module 10. Each event type corresponds to a plurality of reference signals. Each behavior mode comprises a plurality of event types arranged in a specific order. The life mode records a plurality of behavior modes in a plurality of past time intervals and the past time intervals correspond to different time segments of a day. For example, the event types, such as “opening the door of the bathroom”, “turning on the faucet” and “flushing the toilet”, can be previously stored in the storage module 10. Each event type may correspond to different sensing signals. For examples, the event type “opening the door of the bathroom” corresponds to an infrared signal detected when an article is displaced (herein, the article refers to the door knob of the door of the bathroom), and the event type “turning on the faucet” corresponds to an audio signal of a water flow. Moreover, the event type may correspond to more than one type of sensing signal. For one example, the event type “flushing the toilet” can correspond to an infrared signal detected when an article is displaced (herein, the article refers to the flush handle of the toilet) and an audio signal of a water flow. Based on the above examples, the behavior mode can be, for instance, “going to the bathroom”. The behavior mode “going to the bathroom” can comprise a plurality of even types which are arranged in a specific order, such as “opening/closing the door of the bathroom—flushing the toilet—turning on/off the faucet—opening/closing the door of the bathroom”.

The life mode is defined as an average possibility of one behavior mode happening within the overlapped past time intervals. Particularly, the overlapped past time intervals are the past time intervals having a twenty-four fours time interval between each other. For example, the life mode can comprises a behavior mode “coming home” which happened within PM 18:00˜PM 19:00, Nov. 1, 2016, a behavior mode “coming home” which happened within PM 18:00˜PM 19:00, November 2, a behavior mode “taking a bath” which happened within PM 20:00˜PM 21:00, Nov. 1, 2016, a behavior mode “taking a bath” which happened within PM 20:00˜PM 21:00, Nov. 2, 2016, and the like. Regarding to the behavior mode “taking a bath”, the life mode shows an average possibility that the behavior mode “taking a bath” happened within a plurality of past time intervals, such as PM 20:00˜PM 21:00, Nov. 1, 2016 and PM 20:00˜PM 21:00, Nov. 2, 2016.

The event type classification module 12 compares the sensing signals and the reference signals corresponding to the event types, and accordingly determines the event types of the events corresponding to the sensing signals. Specifically speaking, the event type classification module 12 determines the event types of the events corresponding to the sensing signals according to a time duration from a timing when the sensing signals are obtained to a timing when the sensing signals are not obtained, and also according to the type, the geographical information, the signal strength or the frequency of the sensing signals. For example, the types of the sensing signals may be an audio signal, an infrared signal, an ultrasound signal or the like. Additionally, the geographical information of the sensing signals can be obtained, for instance, from a GPS signal.

The behavior evaluation module 18 compares the event types and the specific order of the event types which are related to the determined events within a current time interval, with the event types and the specific order of the event types of each previously stored behavior mode. As a result, the behavior evaluation module 18 can obtain a current behavior mode and a first possibility. For example, the event types and the specific order of the event types determined by the event type classification module 12 within the current time interval (such as PM 18:10˜PM 18:15) are “opening/closing door—dog is barking—opening/closing door”. According to the event types and the specific order of the event types of the behavior modes stored in the storage module 10, the sequential event types “opening/closing door—dog is barking—opening/closing door” are a behavior mode which is “coming home”. Thus, the behavior evaluation module 18 determines that the event types and the specific order of the event types determined within the current time interval is a behavior mode “coming home”.

In this embodiment, the first possibility is defined as a possibility of being in danger in the current behavior mode. It should be noted that, in the outgoing setting of the behavior detection system 1, the first possibility of each behavior mode stored in the storage module 10 is predetermined. For example, generally, the bathroom is a place where people are more likely to be in danger, so in the outgoing setting of the behavior detection system 1, the first possibility of the behavior mode “taking bath” is predetermined as a higher possibility, such as a possibility being more than 50%.

After that, the behavior evaluation module 18 compares the current time interval and the life mode to obtain a second possibility. It should be noted that, the second possibility is defined as a possibility of the current behavior mode being similar to the behavior modes in the past time intervals corresponding to the current time interval. For one example, according to the life mode, a behavior mode “coming home” happened within the past time interval which is PM 18:00˜PM 19:00, Nov. 1, 2016. It is assumed that the behavior evaluation module 18 obtains a current behavior mode which is determined as the behavior mode “coming home”, and that this current behavior mode is obtained within a current time interval which is PM 18:10˜PM 18:15, Nov. 2, 2016. In this case, after comparing the current behavior mode with the life mode, the behavior evaluation module 18 obtains a higher second possibility of the current behavior mode, such as a second possibility being higher than 50%. In another example, according to the life mode, a behavior mode “taking a bath” happened within the past time interval which is PM 20:00˜PM 21:00, Nov. 1, 2016. It is assumed that the behavior evaluation module 18 obtains a current behavior mode which is determined as the behavior mode “taking a bath”, and that this current behavior mode is obtained within a current time interval which is PM 14:10˜PM 14:40, Nov. 2, 2016. In this case, after comparing the current behavior mode with the life mode, the behavior evaluation module 18 obtains a lower second possibility of the current behavior mode, such as a second possibility being lower than 50%.

Finally, the behavior evaluation module 18 determines whether to send a notification to an external device D according to the first possibility and the second possibility. In one example, according to the life mode, a behavior mode “taking a bath” happened within the past time interval which is PM 20:00˜PM 21:00, Nov. 1, 2016, and it is assumed that the current behavior mode is determined as a behavior mode which is “taking a bath”, and that the current behavior mode happened within a current time interval which is PM 20:20˜PM 20:50. In this example, the behavior evaluation module 18 will obtain a first possibility that is higher than 50% and a second possibility that is larger than 50%. In this embodiment, the behavior evaluation module 18 only sends a notification to an external D when the first possibility is higher than a first possibility threshold and when the second possibility is lower than a second possibility threshold. Thus, if the first possibility threshold and the second possibility threshold are both set as 50% in this embodiment, in this example, the behavior evaluation module 18 will not send a notification to an external D because the first possibility and the second possibility are both higher than 50%. In other words, this current behavior mode, which is “taking a bath” and happened within the current time interval (PM 20:20˜PM 20:50), is not considered a behavior that a user needs to be aware of by behavior evaluation module 18.

In another example, it is assumed that the first possibility predetermined for the behavior mode “coming home” that comprises the sequential event types which are “opening the door—dog is barking—closing the door” is 30%, and that the sequential event types in the current behavior mode are “opening the door—dog is barking—closing the door—dog is barking”. In this example, the behavior evaluation module 18 still determines that this current behavior mode is a behavior mode which is “coming home”. However, it is worth mentioning that, because there is an additional event type which is “dog is barking” in the current behavior mode, the behavior evaluation module 18 will not take the first possibility predetermined for the behavior mode “coming home”, which is 30%, as the first possibility of this current behavior mode. The behavior evaluation module 18 will adjust the first possibility of this current behavior mode to be higher than 30%, such as 60%. Also in this example, it is assumed that this current behavior mode happened within the current time interval which is PM 14:10˜PM 14:15, and that the behavior mode “coming home” recorded in the life mode comprises the sequential event types “opening the door—dog is barking—closing the door” and happened within a past time interval which is PM 18:00˜PM 19:00. After the behavior evaluation module 18 compares this current behavior mode and the life mode, the behavior evaluation module 18 will obtain a lower second possibility, such as 30%. Thus, if the first possibility threshold and the second possibility threshold are both set as 50% in this embodiment, in this example, the behavior evaluation module 18 will send a notification to an external D because the first possibility is higher than 50% but the second possibility is lower than 50%. In other words, this current behavior mode, which is “coming home” and happened within the current time interval (PM 14:10˜PM 14:15), is considered a behavior that a user needs to be aware of by behavior evaluation module 18.

From the above, when the behavior detection system obtains a current behavior mode, if this current behavior mode is the same as one of the pre-stored behavior modes, the behavior detection system 1 will take the predetermined first possibility as the first possibility of this current behavior mode. However, if this current behavior mode is only similar to one of the pre-stored behavior modes, the behavior evaluation module 18 will adjust the first possibility of this current behavior mode to be higher or lower than the predetermined first possibility. In addition, the behavior detection system 1 compares this current behavior mode with the life mode to obtain a second possibility for knowing how this current behavior mode is similar to the life mode. In this manner, according to the first possibility and the second possibility, the behavior detection system 1 can accurately send a notification for any behavior that a user needs to be aware of.

It should be noted that, in one embodiment, in a case that the current behavior mode is only similar to one of the pre-stored behavior modes, and the behavior evaluation module 18 needs to adjust the first possibility of this current behavior mode to be higher or lower than the predetermined first possibility, if the predetermined first possibility is higher than the first possibility threshold, the behavior evaluation module 18 still takes the predetermined first possibility as the first possibility of the current behavior mode, but if the predetermined first possibility is lower than the first possibility threshold, the behavior evaluation module 18 adjusts the first possibility of the current behavior mode to be higher than the predetermined first possibility. However, the above description is only for illustrating but not for restricting the mechanism of adjusting the first possibility of a current behavior mode.

The notification sent by the behavior detection system 1 can be an alarm signal or a control signal, and an external device D (such as, a tablet that a user has in hand) will alarm a user according to the alarming signal or an external device D (such as, a smart home appliance) can be controlled by the control signal.

The behavior detection system provided by the instant disclosure can effectively learn each kind of behavior mode and can effectively record and update the life mode, which can be illustrated by another embodiment of the behavior detection system provided by the instant disclosure as blew.

### Another Embodiment of the Instant Disclosure

Referring to FIG. 2, FIG. 2 shows a block diagram of a behavior detection system in another embodiment of the instant disclosure. The behavior detection system 2 can be implemented by hardware devices like a computer, a local server, a cloud server or the combination thereof. The behavior detection system 1 and the behavior detection system 2 have similar module structures and similar working principles, but they still have differences. One of the differences is that the behavior detection system 2 further comprises a behavior capturing module 14 and a life mode training module 16. As shown in FIG. 2, the behavior capturing module 14 and the life mode training module 16 are both connected to the event type classification module 12.

The following description is to illustrate how the behavior capturing module 14 can effectively learn each kind of behavior mode, and how the life mode training module 16 can effectively record and update the life mode.

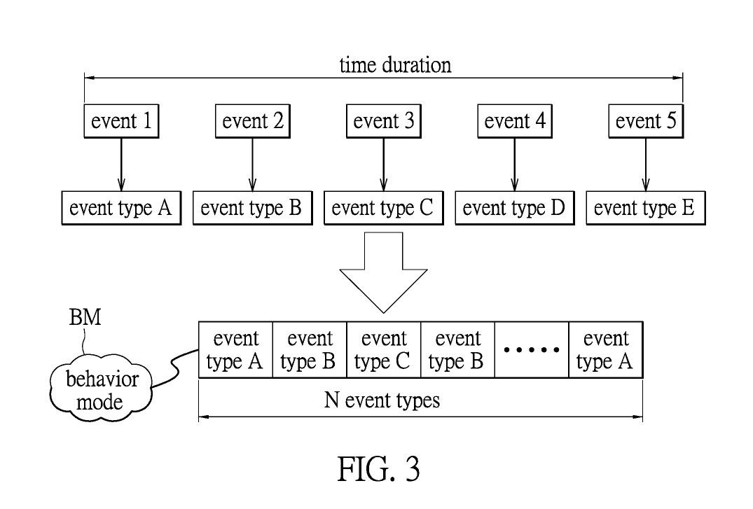

Referring to FIG. 3, FIG. 3 is a block diagram showing how a behavior capturing module in the behavior detection system obtains a behavior mode in one embodiment of the instant disclosure.

As described in the last embodiment, the event type classification module 12 compares sensing signals corresponding to an event and reference signals corresponding to a plurality of event types, and accordingly determines the event type for the event. As shown in FIG. 3, within a time duration, the event type classification module 12 determines there are five events happening sequentially based on the sensing signals, such as an event 1, an event 2, an event 3, an event 4 and an event 5. The event type classification module 12 then determines that the event types of these five events are respectively the event type A, the event type B, the event type C, the event type B and the event type A. According to the event types of the event 1, the event 2, the event 3, the event 4 and the event 5 and the specific order of these five events, the behavior capturing module 14 packages the event types of these five events as a behavior mode BM. In other words, the behavior capturing module 14 learns a behavior mode BM which comprises sequential event types “event type A—event type B—event type C—event type B—event type A”. It should be noted that, in this embodiment, one behavior mode BM can comprise N sequential event types of N events. Although in the embodiment shown by FIG. 3, N equals to five, the amount of the event types of one behavior mode BM is not restricted herein.

For example, within a current time interval which is “PM 20:20˜PM 20:50, Nov. 2, 2016”, the behavior capturing module 14 learns a behavior mode BM which comprises sequential event types “opening/closing the door—showering—brushing—showering—opening/closing the door”. After that, the behavior capturing module 14 searches for one behavior mode pre-stored in the storage module 10, wherein this pre-stored behavior mode comprises the sequential event types which are similar to the above newly learned behavior mode BM. When the similarity between the event types and the specific order of the event types in the above newly learned behavior mode BM, and event types and the specific order of the event types in the pre-stored behavior mode is larger than a predetermined percentage, the behavior capturing module 14 sets the first possibility of the pre-stored behavior mode as the first possibility of the above newly learned behavior mode BM. In the above example, it is assumed that the pre-stored behavior mode which is searched by the behavior capturing module 14 is a behavior mode “taking a bath”, which comprises the sequential event types “opening/closing the door—showering—no signal detected—showering—opening/closing the door”, and the first possibility of this pre-stored behavior mode is 70%. In this case, the behavior capturing module 14 sets 70% as the first possibility of the above newly learned behavior mode BM, which comprises sequential event types “opening/closing the door—showering—brushing—showering opening/closing the door”. Finally, the behavior capturing module 14 stores the event types and the specific order of the event types in the newly learned behavior mode and the first possibility of the newly learned behavior mode in the storage module 10 as one of behavior modes pre-stored in the storage module 10.

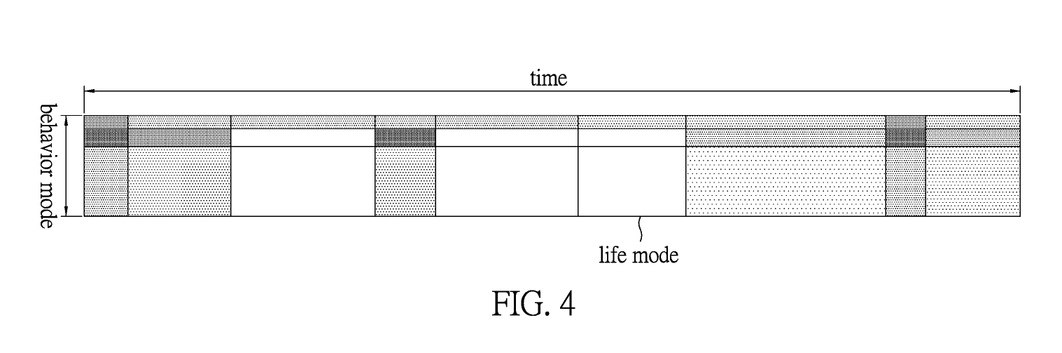

Referring to FIG. 4, FIG. 4 is a block diagram showing how a life mode training module in the behavior detection system obtains a life mode in one embodiment of the instant disclosure.

As described in the last embodiment, the event type classification module 12 compares sensing signals corresponding to an event and reference signals corresponding to a plurality of event types, and accordingly determines the event type for the event. Moreover, the behavior evaluation module 18 compares the event types and the specific order of the event types which are determined within a time duration with the event types and the specific order of the event types in the behavior evaluation modules pre-stored in the storage module 10, to obtain a current behavior mode and a first possibility of the current behavior mode. After that, in this embodiment, according to a timing when the behavior mode determined by the behavior evaluation module 18 happened, the life mode training module 16 takes the determined behavior mode as one of the behavior modes in the past time intervals, to obtain and update the life mode, and store the life mode in the storage module 10.

In this embodiment, the life mode can be represented in a matrix form. As mentioned, the life mode is defined as an average possibility of one behavior mode happening within the overlapped past time intervals, wherein the overlapped past time intervals are the past time intervals having a twenty-four fours time interval between each other. As shown in FIG. 4, the longitudinal axis of a matrix recording the life mode refers to “behavior mode”, and the lateral axis of the matrix recording the life mode refers to “time”. In details, the total time length of the lateral axis is twenty-four hours, and each row along the longitudinal axis refers to one kind of behavior mode. For example,

The life mode training module 16 determines the column at lateral axis according to the timing when one behavior mode happened, and then dots wherein the row of this behavior mode is overlapped with the determined column at lateral axis. In this manner, the row of this behavior mode shows the possibility distribution of this behavior mode during a day. In the matrix shown in FIG. 4, if the lateral axis is segmented into 24 past time intervals and each past time interval is one hour, the row of this behavior mode shows the possibility distribution of this behavior mode in the overlapped past time intervals of pass days. However, the above one-hour past time interval is only for illustrating but not for restricting the instant disclosure. That is, the time length of the past time interval is not restricted herein.

Finally, to optimize the behavior detection system 2 according to users' habits, another difference between the behavior detection system 2 in this embodiment and the behavior detection system 1 shown in FIG. 1 is provided as follows. The behavior detection system 2 further comprises an operation interface 19. Again referring to FIG. 2, the operation interface 19 is connected to the behavior evaluation module 18. By using the operation interface 19, the user can input a feedback message to reset at least one of the first possibility threshold and the second possibility threshold.

### One Embodiment of the Behavior Detection Method

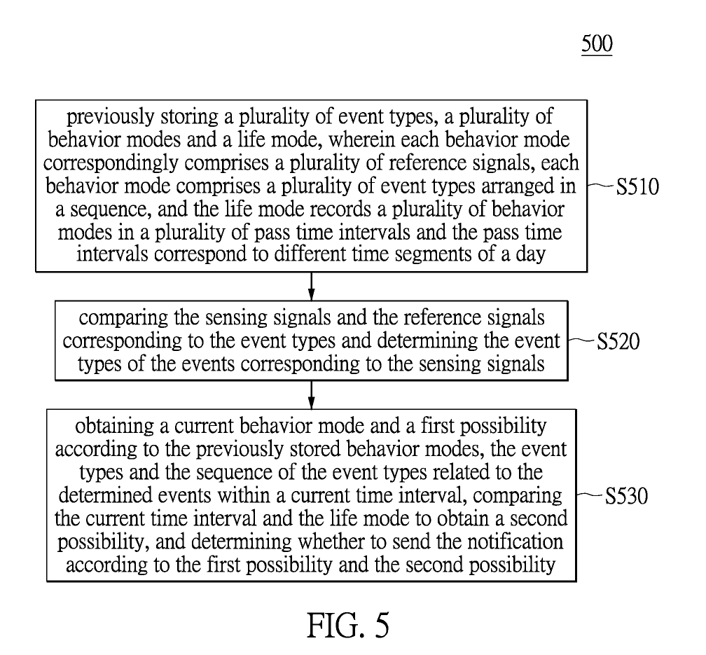

Referring to FIG. 5, FIG. 5 shows a flow chart of a behavior detection method in one embodiment of the instant disclosure. The behavior detection method 500 in this embodiment can be adapted to the behavior detection system 1 shown in FIG. 1, and thus please refer to FIG. 1 for further understanding.

The behavior detection method 500 mainly comprises steps as follows: previously storing a plurality of event types, a plurality of behavior modes and a life mode, wherein each event type corresponds to a plurality of reference signals, each behavior mode comprises a plurality of event types arranged in a specific order, and the life mode records a plurality of behavior modes in a plurality of past time intervals and the past time intervals correspond to different time segments of a day (step S510); comparing the sensing signals and the reference signals corresponding to the event types and determining the event types of the events corresponding to the sensing signals (step S520); and obtaining a current behavior mode and a first possibility according to the previously stored behavior modes, the event types and the specific order of the event types related to the determined events within a current time interval, comparing the current time interval and the life mode to obtain a second possibility, and determining whether to send the notification according to the first possibility and the second possibility (step S530).

Relevant details of the steps of the behavior detection method 500 regarding the behavior detection system 1 are described in the embodiment shown in FIG. 1, and thus it is not repeated thereto. It is clarified that, a sequence of steps of the behavior detection method 500 shown in FIG. 5 is set for a need to instruct easily, and thus the sequence of the steps is not used as a condition in demonstrating the embodiments of the instant disclosure.

### Another Embodiment of the Behavior Detection Method

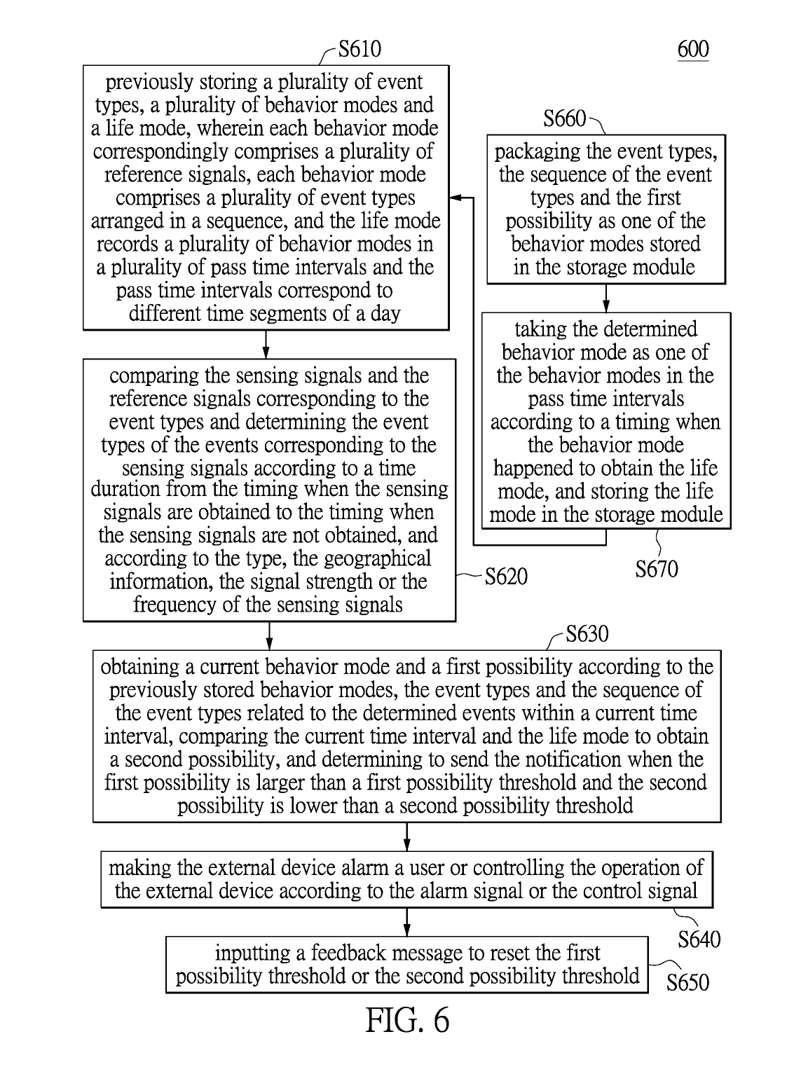

Referring to FIG. 6, FIG. 6 shows a flow chart of a behavior detection method in another embodiment of the instant disclosure. The behavior detection method 600 in this embodiment can be adapted to the behavior detection system 2 shown in FIG. 2, and thus please refer to FIG. 2 for further understanding.

The behavior detection method 500 mainly comprises steps as follows: previously storing a plurality of event types, a plurality of behavior modes and a life mode, wherein each event type corresponds to a plurality of reference signals, each behavior mode comprises a plurality of event types arranged in a specific order, and the life mode records a plurality of behavior modes in a plurality of past time intervals and the past time intervals correspond to different time segments of a day (step S610); comparing the sensing signals and the reference signals corresponding to the event types and determining the event types of the events corresponding to the sensing signals according to a time duration from a timing when the sensing signals are obtained to a timing when the sensing signals are not obtained, and according to the type, the geographical information, the signal strength or the frequency of the sensing signals (step S620); obtaining a current behavior mode and a first possibility according to the previously stored behavior modes, the event types and the specific order of the event types related to the determined events within a current time interval, comparing the current time interval and the life mode to obtain a second possibility, and determining to send the notification when the first possibility is larger than a first possibility threshold and the second possibility is lower than a second possibility threshold (step S630); making the external device alarm a user or controlling the operation of the external device according to the alarm signal or the control signal (step S640); and inputting a feedback message to reset the first possibility threshold or the second possibility threshold (step S650).

In addition, to effectively learn each kind of behavior mode and to effectively record and update the life mode, the behavior detection method 600 further comprises: packaging the event types, the specific order of the event types and the first possibility as one of the behavior modes pre-stored in the storage module (step S660); and taking the determined behavior mode as one of the behavior modes in the past time intervals according to a timing when the behavior mode happened to obtain the life mode, and storing the life mode in the storage module (step S670)

Relevant details of the steps of the behavior detection method 600 regarding the behavior detection system 2 are described in the embodiment shown in FIG. 2, and thus it is not repeated thereto. It is clarified that, a sequence of steps of the behavior detection method 600 shown in FIG. 6 is set for a need to instruct easily, and thus the sequence of the steps is not used as a condition in demonstrating the embodiments of the instant disclosure.

To sum up, the behavior detection system and the behavior detection method provided by the instant disclosure can detect a behavior according to different types of signals, such as audio signals, infrared signals or the like. The behavior detection system and the behavior detection method provided by the instant disclosure can be used in home appliances, to determine whether there is anyone being in danger at home. For example, the elderly may fall down but cannot stand up by themselves. The traditional detection system usually detect a behavior based on single type of signals, and in this manner a behavior may be wrongly determined as a dangerous one. On the contrary, the behavior detection system and method provided by the instant disclosure can detect a behavior according to different types of signals and based on the behavior modes learned by the behavior capturing module and the life mode obtained by the life mode training module, so the behavior detection system and method provided by the instant disclosure can precisely determine whether the detected behavior makes one in danger (or determine the possibility that one may be in danger because of the detected behavior happened), and it will be less likely to wrongly send a notification to warn a user.

In addition, the behavior detection system provided by the instant disclosure can continually learn life modes through the behavior capturing module, and can continually update the life mode which is pre-stored in the storage module, such that the behavior detection system provided by the instant disclosure can be optimized according to users' life habits and thus there will be less error notification sent.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

1. A behavior detection system, obtaining a plurality of sensing signals from a plurality of sensors to detect a behavior and accordingly determining whether to send a notification to an external device, the behavior detection system comprising:
a storage module, previously storing a plurality of event types, a plurality of behavior modes and a life mode, wherein each event type corresponds to a plurality of reference signals, each behavior mode comprises a plurality of event types arranged in a specific order, and the life mode records a plurality of behavior modes in a plurality of past time intervals and the past time intervals correspond to different time segments of a day;
an event type classification module, connected to the storage module, comparing the sensing signals and the reference signals corresponding to the event types and determining the event types of the events corresponding to the sensing signals; and
a behavior evaluation module, connected to the storage module and the event type classification module, obtaining a current behavior mode and a first possibility according to the previously stored behavior modes, the event types and the specific order of the event types related to the determined events within a current time interval, comparing the current time interval and the life mode to obtain a second possibility, and determining whether to send the notification according to the first possibility and the second possibility;
wherein the first possibility is defined as a possibility of being in danger in the current behavior mode, and the second possibility is defined as a possibility of the current behavior mode being similar to the behavior modes in the past time intervals corresponding to the current time interval.

2. The behavior detection system according to claim 1, further comprising:
a behavior capturing module, connected to the event type classification module, packaging the event types, the specific order of the event types and the first possibility as one of the behavior modes stored in the storage module.

3. The behavior detection system according to claim 1, further comprising:
a life mode training module, connected to the event type classification module, taking the determined behavior mode as one of the behavior modes in the past time intervals according to a timing when the behavior mode happened to obtain the life mode, and storing the life mode in the storage module.

4. The behavior detection system according to claim 1, wherein the event type classification module determines the event types of the events corresponding to the sensing signals according to a time duration from a timing when the sensing signals are obtained to a timing when the sensing signals are not obtained, and according to one of the type, the geographical information, the signal strength and the frequency of the sensing signals.

5. The behavior detection system according to claim 2, wherein when the similarity of one behavior mode obtained by the behavior capturing module and one of the behavior modes previously stored in the storage module is larger than a predetermined percentage, the first possibility of the behavior mode obtained by the behavior capturing module is set as the first possibility of the previously stored behavior mode.

6. The behavior detection system according to claim 1, wherein the life mode is defined as an average possibility of one behavior mode happening within the overlapped past time intervals, wherein the overlapped past time intervals are the past time intervals having a twenty-four fours time interval between each other.

7. The behavior detection system according to claim 1, wherein when the first possibility is larger than a first possibility threshold and the second possibility is lower than a second possibility threshold, the behavior evaluation module sends the notification.

8. The behavior detection system according to claim 1, wherein the notification is an alarm signal or a control signal to make the external device alarm a user or to control the operation of the external device.

9. The behavior detection system according to claim 1, further comprising:
an operation interface, connected to the behavior evaluation module, configured to have a feedback message inputted for resetting the first possibility threshold or the second possibility threshold.

10. The behavior detection system according to claim 1, wherein the sensors at least comprise an infrared camera and an audio detector, and the sensing signals at least comprise an infrared signal and an audio signal.

11. A behavior detection method, adapted to a behavior detection system, wherein the behavior detection system obtains a plurality of sensing signals from a plurality of sensors to detect a behavior and accordingly determines whether to send a notification to an external device, the behavior detection system comprises a storage module, an event type classification module and a behavior evaluation module, and the event type classification module and the behavior evaluation module are connected to the storage module, the behavior detection method comprising:
through the storage module, previously storing a plurality of event types, a plurality of behavior modes and a life mode, wherein each event type corresponds to a plurality of reference signals, each behavior mode comprises a plurality of event types arranged in a specific order, and the life mode records a plurality of behavior modes in a plurality of past time intervals and the past time intervals correspond to different time segments of a day;
through the event type classification module, comparing the sensing signals and the reference signals corresponding to the event types and determining the event types of the events corresponding to the sensing signals; and
through the behavior evaluation module, obtaining a current behavior mode and a first possibility according to the previously stored behavior modes, the event types and the specific order of the event types related to the determined events within a current time interval, comparing the current time interval and the life mode to obtain a second possibility, and determining whether to send the notification according to the first possibility and the second possibility;
wherein the first possibility is defined as a possibility of being in danger in the current behavior mode, and the second possibility is defined as a possibility of the current behavior mode being similar to the behavior modes in the past time intervals corresponding to the current time interval.

12. The behavior detection method according to claim 11, wherein the behavior detection system further comprises a behavior capturing module and the behavior capturing module is connected to the event type classification module, the behavior detection method further comprising:
through the behavior capturing module, packaging the event types, the specific order of the event types and the first possibility as one of the behavior modes stored in the storage module.

13. The behavior detection method according to claim 11, wherein the behavior detection system further comprises a life mode training module and the life mode training module is connected to the event type classification module, the behavior detection method further comprising:
through the life mode training module, taking the determined behavior mode as one of the behavior modes in the past time intervals according to a timing when the behavior mode happened to obtain the life mode, and storing the life mode in the storage module.

14. The behavior detection method according to claim 11, wherein the step of comparing the sensing signals and the reference signals corresponding to the event types and determining the event types of the events corresponding to the sensing signals comprises:
through the event type classification module, determining the event types of the events corresponding to the sensing signals according to a time duration from a timing when the sensing signals are obtained to a timing when the sensing signals are not obtained, and according to the type, the geographical information, the signal strength or the frequency of the sensing signals.

15. The behavior detection method according to claim 11, wherein when the similarity of one behavior mode obtained by the behavior capturing module and one of the behavior modes previously stored in the storage module is larger than a predetermined percentage, the first possibility of the behavior mode obtained by the behavior capturing module is set as the first possibility of the previously stored behavior mode.

16. The behavior detection method according to claim 11, wherein the life mode is defined as an average possibility of one behavior mode happening within the overlapped past time intervals, wherein the overlapped past time intervals are the past time intervals having a twenty-four fours time interval between each other.

17. The behavior detection method according to claim 11, wherein the step of determining whether to send the notification according to the first possibility and the second possibility comprises:
through the behavior evaluation module, sending the notification when the first possibility is larger than a first possibility threshold and the second possibility is lower than a second possibility threshold.

18. The behavior detection method according to claim 11, wherein the notification is an alarm signal or a control signal, the behavior detection method further comprises:
making the external device alarm a user or controlling the operation of the external device according to the alarm signal or the control signal.

19. The behavior detection method according to claim 11, wherein the behavior detection system further comprises an operation interface and the operation interface is connected to the behavior evaluation module, the behavior detection method comprising:
through the operation interface, having a feedback message inputted for resetting the first possibility threshold or the second possibility threshold.

20. The behavior detection method according to claim 11, wherein the sensors at least comprise an infrared camera and an audio detector, and the sensing signals at least comprise an infrared signal and an audio signal.
